(19) United States
(12) Patent Application Publication
(10) Pub. No.: US 2026/0321510 A1
(43) Pub. Date: Oct. 15, 2026

(54) ELECTRONIC COMPONENT AND METHOD FOR MANUFACTURING ELECTRONIC COMPONENT

(71) Applicant: Murata Manufacturing Co., Ltd., Nagaokakyo-shi (JP)

(72) Inventors: Daisho TSUBOKAWA, Nagaokakyo-shi (JP); Tomoya OOSHIMA, Nagaokakyo-shi (JP); Yuuta HOSHINO, Nagaokakyo-shi (JP)

(21) Appl. No.: 19/685,223

(22) Filed: May 22, 2026

Related U.S. Application Data
(63) Continuation of application No. PCT/JP2024/041995, filed on Nov. 27, 2024.

(30) Foreign Application Priority Data
Nov. 29, 2023 (JP) 2023-201721

(51) Int. Cl. H01G 4/30; H01G 4/012; H01G 4/248

(52) U.S. Cl. CPC H01G 4/30; H01G 4/012; H01G 4/248

(57) ABSTRACT

An electronic component is provided that includes a base body and a glass film covering an outer surface of the base body. The outer surface of the base body includes a recessed portion that is recessed relative to surrounding surfaces. The material of the glass film includes an organosilane compound. The glass film has a plurality of voids ) therein. In a sectional view taken along a plane orthogonal to the outer surface of the base body, a ratio of a total area of the plurality of voids to a sectional area of the glass film is 0.3% or more and 30% or less at a portion covering the recessed portion in the glass film.

### CROSS REFERENCE TO RELATED APPLICATIONS

The present application is a continuation of International application No. PCT/JP2024/041995, filed Nov. 27, 2024, which claims priority to Japanese Patent Application No. 2023-201721, filed Nov. 29, 2023, the entire contents of each of which are incorporated herein by reference.

### TECHNICAL FIELD

The present disclosure relates to an electronic component and a method for manufacturing an electronic component.

### BACKGROUND

The electronic component disclosed in Japanese Patent No. 4868019 includes a base body and a glass film. As described therein, the glass film covers the outer surface of the base body. Moreover, the glass film is formed by spraying glass slurry onto the base body housed in a rotating barrel, and the film thickness of the glass film is 5 μm to 30 μm.

In the electronic component as disclosed in Japanese Patent No. 4868019, the outer surface of the base body may have a recessed portion that is a portion recessed relative to surrounding surfaces. In the electronic component as disclosed in Japanese Patent No. 4868019, the glass film fills the recessed portion. Therefore, the thickness of the glass film is greater at a portion covering the recessed portion than at other portions. As described above, when the glass film has a portion having a large film thickness, stress is likely to occur in the portion having a large film thickness with temperature change, so that cracks and the like are likely to occur in a portion of the glass film covering the recessed portion.

### SUMMARY

In view of the foregoing, an electronic component is provided that includes a base body; and a glass film covering an outer surface of the base body, in which the outer surface of the base body includes a recessed portion that is recessed relative to surrounding surfaces. Moreover, a material of the glass film includes an organosilane compound, the glass film has a plurality of voids therein, and in a sectional view taken along a plane orthogonal to the outer surface of the base body, a ratio of a total area of the plurality of voids to a sectional area of the glass film is 0.3% or more and 30% or less at a portion covering the recessed portion in the glass film.

In addition, a method for manufacturing an electronic component is provided that includes preparing a base body; charging the base body into a reaction vessel; charging one or more elements selected from a metal alkoxide and a metal alkoxide precursor, together with an organosilane compound into the reaction vessel; forming a glass film on an outer surface of the base body by stirring within the reaction vessel and hydrolyzing and condensation-polymerizing the metal alkoxide; and charging a medium which is in a powder form having a higher hardness than the base body and has a particle diameter greater than a maximum dimension of a line segment connecting two points on an opening edge of a recessed portion included in an outer surface of the base body into the reaction vessel. In this aspect, the charging of the medium is performed before or during the forming of the glass film.

In view of the exemplary aspects, crack formation can be suppressed in a portion covering a recessed portion of a glass film.

### BRIEF DESCRIPTION OF DRAWINGS

FIG. 1 is a perspective view of an electronic component.

FIG. 2 is a side view of the electronic component.

FIG. 3 is a sectional view taken along line 3-3 in FIG. 2.

FIG. 4 is an enlarged sectional view of a recess.

FIG. 5 is an enlarged sectional view of a recess.

FIG. 6 is a flowchart for explaining a manufacturing process of an electronic component.

FIG. 7 is an explanatory diagram illustrating a method for manufacturing an electronic component.

FIG. 8 is an explanatory diagram illustrating a method for manufacturing an electronic component.

FIG. 9 is an explanatory diagram illustrating a method for manufacturing an electronic component.

FIG. 10 is an explanatory diagram illustrating a method for manufacturing an electronic component.

FIG. 11 is an explanatory diagram illustrating a method for manufacturing an electronic component.

### DETAILED DESCRIPTION

### Exemplary Embodiment of Electronic Component

Hereinafter, an exemplary embodiment of the electronic component will be described with reference to the drawings. It is to be noted that components may be shown in an enlarged manner for easy understanding in the drawings. In some cases, the dimension ratio of a component differs from an actual dimension ratio or a dimension ratio in another drawing.

### (Overall Configuration)

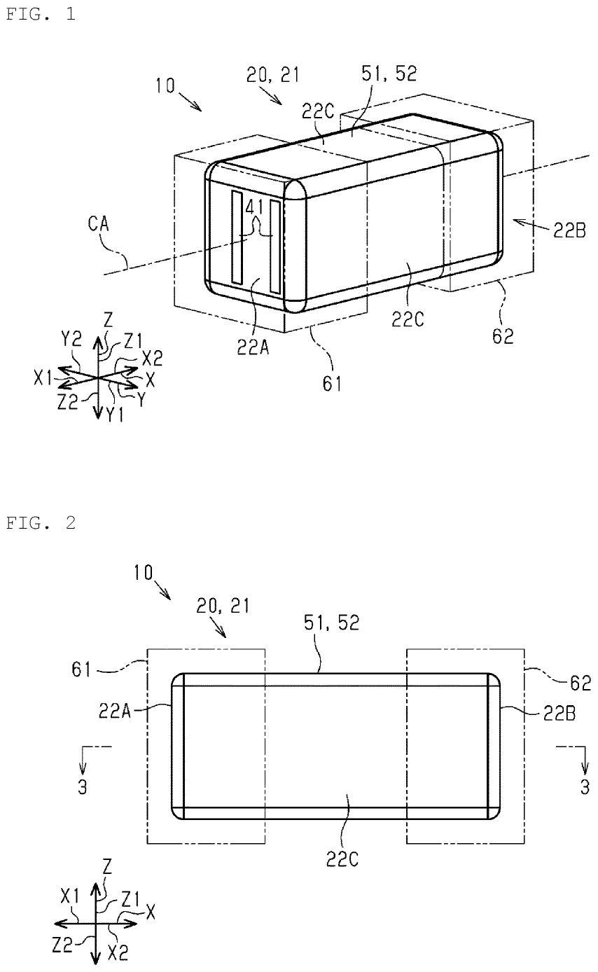

As shown in FIG. 1, an electronic component 10 is, for example, a surface-mount negative-characteristic thermistor component to be mounted on a circuit board or the like. The negative-characteristic thermistor component has a characteristic that the resistance value decreases as the temperature increases.

The electronic component 10 includes a base body 20. In the exemplary aspect, the base body 20 has a substantially quadrangular prism shape and has a central axis CA. For purposes of this disclosure, an axis extending along the central axis CA is defined as a first axis X. In addition, one of the axes that are orthogonal to the first axis X is defined as a second axis Y. Further, an axis that is orthogonal to the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Further, one of the directions along the third axis Z is defined as a third positive direction Z1, and a direction opposite to the third positive direction Z1, of the directions along the third axis Z, is defined as a third negative direction Z2.

An outer surface 21 of the base body 20 has six planes. For purposes of this disclosure, the term “surface” of the base body 20 as used herein refers to a part that can be observed as a surface when the entire base body 20 is observed. More specifically, for example, when there are such minute irregularities or steps that fail to be found unless a part of the base body 20 is enlarged and then observed with a microscope or the like, the surface is expressed as a plane or a curved surface. The six planes face different directions as shown. The six planes are roughly divided into a first end surface 22A facing the first positive direction X1, a second end surface 22B facing the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

In the outer surface 21 of the base body 20, a boundary portion between two adjacent planes and a boundary portion between three adjacent surfaces are curved surfaces. That is, the corners of the base body 20 are R-chamfered. In FIGS. 1 and 2, an outer surface 52 of a glass film 51 to be described later is denoted by the same reference numeral as the outer surface 21 of the base body 20.

As shown in FIG. 2, the base body 20 has a dimension in the direction along the first axis X that is greater than a dimension in the direction along the third axis Z. Furthermore, as shown in FIG. 1, in the base body 20, the dimension in the direction along the first axis X is greater than the dimension in the direction along the second axis Y. In addition, the material of the base body 20 is a ceramic obtained by firing a metal oxide including one or more elements selected from Mn, Fe, Ni, Co, Ti, Ba, Al, and Zn as a component.

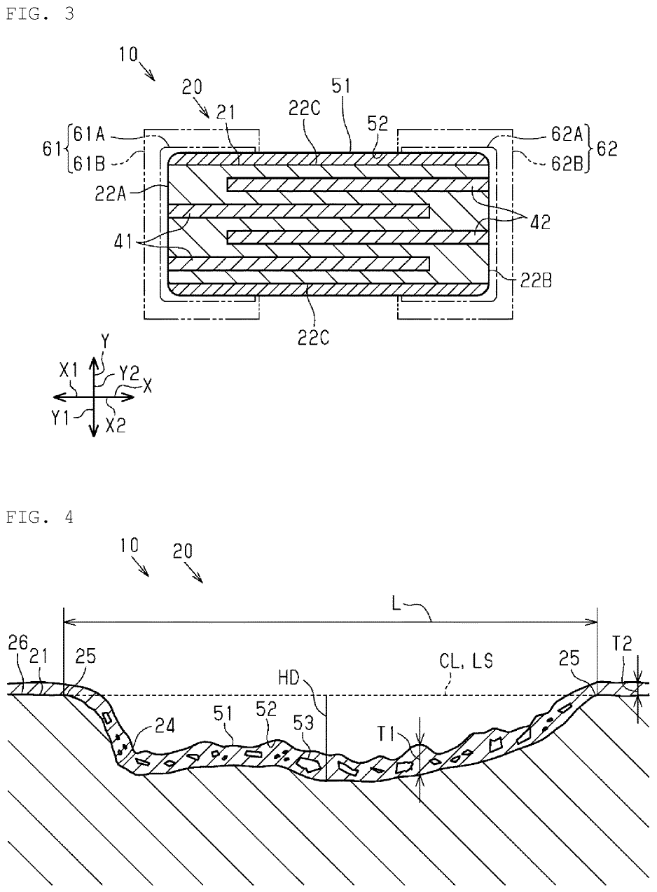

As shown in FIG. 3, the electronic component 10 includes two first internal electrodes 41 and two second internal electrodes 42. The first internal electrodes 41 and the second internal electrodes 42 are embedded in the base body 20 in this aspect.

The material of the first internal electrode 41 is a conductive material, which can be palladium, for example. The material of the second internal electrode 42 is the same as the material of the first internal electrode 41.

The first internal electrode 41 has a rectangular plate shape. The first internal electrode 41 has a main surface that is orthogonal to the second axis Y. The second internal electrode 42 has the same rectangular plate shape as the first internal electrode 41. The second internal electrode 42 has a main surface orthogonal to the second axis Y, as with the first internal electrode 41.

The dimension of the first internal electrode 41 in the direction along the first axis X is smaller than the dimension of the base body 20 in the direction along the first axis X. In addition, as shown in FIG. 1, the dimension of the first internal electrode 41 in the direction along the third axis Z is approximately ⅔ of the dimension of the base body 20 in the direction along the third axis Z. The dimension of the second internal electrode 42 in each of the directions is the same as that of the first internal electrode 41.

As shown in FIG. 3, the first internal electrodes 41 and the second internal electrodes 42 are located in a staggered manner in the direction along the second axis Y. More specifically, the first internal electrode 41, the second internal electrode 42, the first internal electrode 41, and the second internal electrode 42 are arranged in this order in the second negative direction Y2 from the side surface 22C facing in the second positive direction Y1. According to this embodiment, the distances between the respective internal electrodes in the direction along the second axis Y are equal to each other.

As shown in FIG. 1, the two first internal electrodes 41 and the two second internal electrodes 42 are both located at the center of the base body 20 in the direction along the third axis Z. On the other hand, as shown in FIG. 3, the first internal electrodes 41 are located so as to be shifted in the first positive direction X1. The second internal electrodes 42 are located so as to be shifted in the first negative direction X2.

Specifically, an end of the first internal electrode 41 on a side of the first positive direction X1 coincides with an end of the base body 20 on a side of the first positive direction X1. That is, the end of the first internal electrode 41 on the side of the first positive direction X1 is exposed at the first end surface 22A of the base body 20. An end of the first internal electrode 41 on a side of the first negative direction X2 is located inside the base body 20 and does not reach an end of the base body 20 on a side of the first negative direction X2. On the other hand, an end of the second internal electrode 42 on a side of the first negative direction X2 coincides with the end of the base body 20 on a side of the first negative direction X2. That is, the end of the first internal electrode 41 on the side of the first negative direction X2 is exposed at the second end surface 22B of the base body 20. An end of the second internal electrode 42 on the side of the first positive direction X1 is located inside the base body 20 and does not reach the end of the base body 20 on the side of the first positive direction X1.

As shown in FIG. 3, the electronic component 10 includes the glass film 51. The glass film 51 covers the outer surface 21 of the base body 20. In the present embodiment, the glass film 51 covers all four side surfaces 22C of the outer surface 21 of the base body 20. A main material of the glass film 51 is insulating glass in the exemplary aspect. Therefore, the glass film 51 includes silicon dioxide and can further include an organosilane compound having a carbon chain with three or more carbon atoms. The organosilane compound has, for example, one or more functional groups selected from an epoxy group, a mercapto group, an amino group, a vinyl group, and a methacryl group. Specifically, the organosilane compound is 3-glycidoxypropyltrimethoxysilane (hereinafter referred to as “GPTMS”). It is noted that GPTMS has an epoxy group as a functional group.

As shown in FIG. 3, the electronic component 10 includes a first external electrode 61 and a second external electrode 62. It is noted that the first external electrode 61 and the second external electrode 62 are indicated by two-dot chain lines in FIGS. 1 to 3.

The first external electrode 61 includes a first underlying electrode 61A and a first metal layer 61B. The first underlying electrode 61A is laminated at a part of the outer surface 21 of the base body 20, including the first end surface 22A. Specifically, the first underlying electrode 61A covers the first end surface 22A of the base body 20 and covers a part of the four side surfaces 22C on the side of the first positive direction X1 from above the glass film 51. That is, the first underlying electrode 61A is a five-face electrode. In this embodiment, the material of the first underlying electrode 61A is a mixture of an organic resin and silver particles.

The first metal layer 61B covers the first underlying electrode 61A from the outside. Therefore, the first metal layer 61B is laminated on the first underlying electrode 61A. Although not shown in the drawing, the first metal layer 61B has a two-layer structure of a nickel layer and a tin layer in this order from a side of the first underlying electrode 61A. The first external electrode 61 is connected to an end of the first internal electrode 41 on the side of the first positive direction X1.

Similarly, the second external electrode 62 includes a second underlying electrode 62A and a second metal layer 62B. The second underlying electrode 62A is laminated on a part of the outer surface 21 of the base body 20 including the second end surface 22B. Specifically, the second underlying electrode 62A covers the second end surface 22B of the base body 20 and covers a part of the four side surfaces 22C on the side of the first negative direction X2 from above the glass film 51. That is, the second underlying electrode 62A is a five-face electrode. In this embodiment, the material of the second underlying electrode 62A is a mixture of an organic resin and silver particles.

The second metal layer 62B covers the second underlying electrode 62A from the outside. Therefore, the second metal layer 62B is laminated on the second underlying electrode 62A. Specifically, similarly to the first metal layer 61B, the second metal layer 62B has a two-layer structure of nickel plating and tin plating. The second external electrode 62 is connected to an end of the second internal electrode 42 on the side of the first negative direction X2.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not stacked at the central portion in the direction along the first axis X, and the glass film 51 is exposed.

### (Recessed Portion)

As shown in FIG. 4, the outer surface 21 of the base body 20 has one or more recessed portions 24. The recessed portion 24 is a portion recessed toward the inner side of the base body 20 relative to surrounding surfaces. In addition, the glass film 51 described above also covers the recessed portions 24 of the outer surface 21 of the base body 20. The glass film 51 substantially follows the recessed shape of the recessed portion 24. That is, the outer surface 52 of the glass film 51 covering the recessed portion 24 is recessed toward the inner side of the base body 20 relative to surrounding surfaces. The recessed portion 24 is formed due to falling off of ceramic particles, cracking and chipping of the base body 20, and the like.

In the present embodiment, the recessed portion 24 is defined as a recess having a maximum depth HD that is 10 times or greater than the arithmetic average roughness of the outer surface 21 of the base body 20. The maximum depth HD of the recessed portion 24 is the depth at the deepest portion of the recessed portion 24. Specifically, the maximum depth HD of the recessed portion 24 is calculated as follows. First, the base body 20 is ground in a direction orthogonal to the outer surface 21 of the base body 20. The grinding is performed by, for example, focused ion beam processing. Next, the ground section of the base body 20 is imaged using an electron microscope or the like. The imaging magnification in the electron microscope is, for example, 10,000 times or more and 30,000 times or less. Then, as shown in FIG. 4, in the imaged ground section, a tangent line CL that is circumscribed about the outer surfaces 21 of the base body 20 on both sides of the recessed portion 24 is drawn. It is noted that a part of the tangent line CL may coincide with the outer surface 21 of the base body 20. In this case, the length from the tangent line CL to the inner surface of the recessed portion 24 in the direction orthogonal to the tangent line CL is defined as the depth of the recessed portion 24. Subsequently, a new ground section of the base body 20 is imaged by further grinding the base body 20 by a predetermined imaging pitch from the ground section. It is also noted that the imaging pitch is, for example, 10 nm. The maximum depth of the same recessed portion 24 in this new ground section is measured. In this manner, the imaging of the ground section of the base body 20 and the measurement of the maximum depth of the recessed portion 24 are repeated. Among the maximum depths of the recessed portion 24 in each ground section obtained as a result, the largest value is set as the maximum depth HD of the entire recessed portion 24. The maximum depth HD of the recessed portion 24 calculated by this method is 0.3 μm or more and 10 μm or less.

At a point of contact between the tangent line CL drawn by the above-described method and the outer surface 21 of the base body 20, an end on the center side of the recessed portion 24 is defined as an opening edge 25. The maximum dimension L of a line segment LS connecting two points on the opening edge 25 of the recessed portion 24 is 0.5 μm or more and 20 μm or less. In other words, in a case where a plurality of line segments LS connecting two points on the opening edge 25 of the recessed portion 24 are drawn, the dimension L of the longest line segment LS among the plurality of line segments LS is 0.5 μm or more and 20 μm or less. In FIG. 4, the line segment LS is indicated by a chain line. In addition, the line segment LS overlaps with a part of the tangent line CL described above.

In the outer surface 21 of the base body 20, the arithmetic average roughness of the recessed portion 24 is 6 nm or more and 500 nm or less. A preferable range of the arithmetic average roughness of the recessed portion 24 is 6 nm or more and 250 nm, and a more preferable range is 6 nm or more and 100 nm or less. The arithmetic average roughness of the portion covering the recessed portion 24 is measured within a range between the opening edges 25 of one recessed portion 24 specified by the above-described method and within a range of 500 nm in the direction along the tangent line CL. Then, the arithmetic average roughness of the glass film 51 at the portion covering the recessed portion 24 in the measurement range is calculated by image analysis. In calculating the arithmetic average roughness, a laser microscope, a white interferometer, or the like may be used in addition to the above-described method.

### (Glass Film Covering Recessed Portion)

A portion of the outer surface 21 of the base body 20 excluding the recessed portion 24 is defined as a flat portion 26. In this case, the average value of a thickness T1 of the glass film 51 covering the recessed portion 24 is greater than the average value of a thickness T2 of the glass film 51 covering the flat portion 26. However, the average value of the thickness of the entire glass film 51 is 15 nm or more and 10 μm or less. In addition, a preferable range of the average value of the thicknesses of the entire glass film 51 is 15 nm or more and 5 μm or less, and a more preferable range is 15 nm or more and 1 μm or less. The average value of the thickness of the glass film 51 is calculated as follows. First, a section of the base body 20 is imaged using an electron microscope. For this captured image, a range of at least 10 μm or more in a direction along the outer surface 52 of the glass film 51 is defined as a measurement range. Then, a sectional area of the glass film 51 in the measurement range is calculated by image processing. It is noted that the sectional area of the glass film 51 also includes an area of a void 53 to be described later. Next, the sectional area is divided by the length of the measurement range in the direction along the outer surface 52 of the glass film 51. As a result, an average value of the thicknesses of the glass film 51 in the measurement range is calculated. That is, the average value of the thicknesses of the glass film 51 is an average value of the thicknesses in the measurement range. In a case where the thickness T1 at the portion covering the recessed portion 24 of the glass film 51 is obtained by the above method, the total measurement range may be 10 μm or more by specifying the measurement range for the plurality of recessed portions 24.

### (Void)

As shown in FIG. 4, the glass film 51 has a plurality of voids 53 therein. The void 53 is a cavity formed inside the glass film 51 in the film forming step S18 of the manufacturing method described later. Therefore, the void 53 does not include a cavity that is open on the side of the outer surface 52 of the glass film 51, but is a cavity sealed inside the glass film 51. In a sectional view taken along a plane orthogonal to the outer surface 21 of the base body 20 by the above-described method, the area per void 53 is 1 nm² or more and 10,000 nm² or less. In addition, a preferable range of the area per void 53 is 1 nm² or more and 5000 nm² or less, and a more preferable range is 1 nm² or more and 2500 nm² or less. The area per void 53 is an average value of the voids 53 that can be observed in the sectional view. That is, the area per void 53 is a numerical value obtained by dividing the total area of the voids 53 in the sectional view by the number of voids 53.

In a sectional view taken along a plane orthogonal to the outer surface 21 of the base body 20, the ratio of the total area of the plurality of voids 53 to the sectional area of the glass film 51 is 0.3% or more and 30% or less at a portion of the glass film 51 covering the recessed portion 24. A preferable range of the ratio is 0.5% or more and 20% or less, and a more preferable range is 1% or more and 10% or less. Hereinafter, the ratio of the total area of the plurality of voids 53 to the sectional area of the glass film 51 in a sectional view taken along a plane orthogonal to the outer surface 21 of the base body 20 is referred to as a porosity. The section orthogonal to the outer surface 21 of the base body 20 in this case is, for example, a ground section that can be observed by a scanning transmission electron microscope (STEM) using energy dispersive X-ray spectroscopy (EDX) when the base body 20 is ground by the above-described method. That is, the ground section is an EDX image showing EDX mapping data of a principal component of glass. In this section, the total area of the plurality of voids 53 is divided by the sectional area of the glass film 51 and converted into a percentage, thereby calculating the porosity. For purposes of this disclosure, the phrase “sectional area of the glass film 51” also includes the area of the voids 53 in the section.

According to an exemplary aspect, the porosity at the portion of the glass film 51 that covers the recessed portion 24 is greater than the porosity at the portion of the glass film 51 that covers the flat portion 26. Specifically, while the portion of the glass film 51 covering the recessed portion 24 has a porosity of 0.3% or more and 30% or less, the portion of the glass film 51 covering the flat portion 26 has a porosity of less than 0.3%. In this embodiment, the void 53 is not confirmed in the flat portion 26, and thus the porosity at the portion covering the flat portion 26 is 0%. This is presumed to be due to the crushing of the void 53 at the portion covering the flat portion 26 in the glass film 51 in a film forming step S18 of the manufacturing method described later.

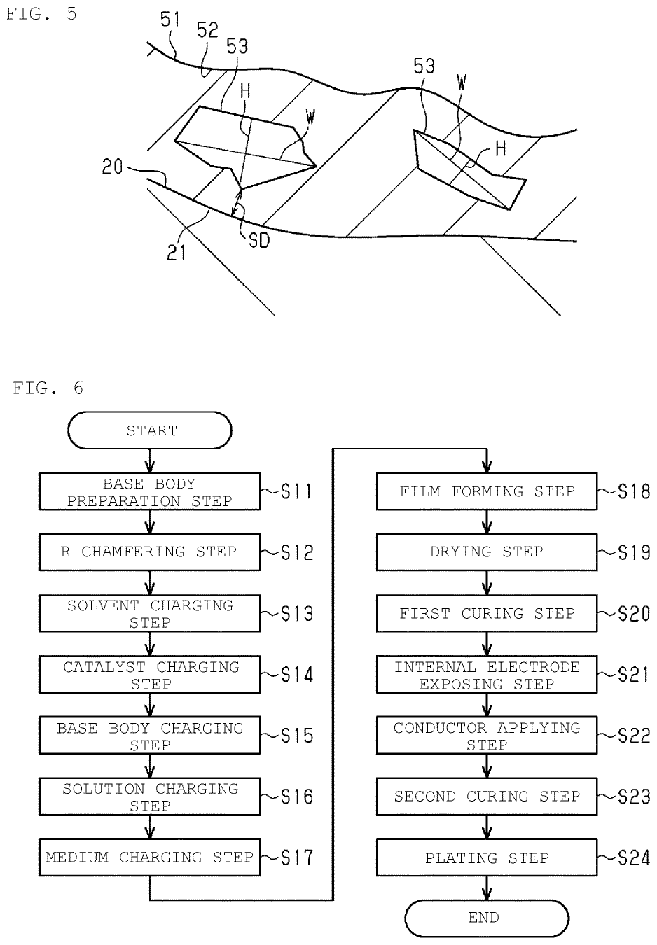

As shown in FIG. 5, in a sectional view taken along a plane orthogonal to the outer surface 21 of the base body 20 by the above-described method, a shortest distance SD between the void 53 and the outer surface 21 of the base body 20 is 15 nm or more. Further, one void 53 is selected from the plurality of voids 53, and a plurality of line segments connecting two points on the outer edge of the void 53 are assumed. Among the plurality of line segments, a line segment having a maximum distance between two points is defined as a first line segment W. Among the plurality of line segments, a line segment passing through the midpoint of the first line segment W and orthogonal to the first line segment W is defined as a second line segment H. The dimension of the first line segment W is 1.01 times or more and 10 times or less the dimension of the second line segment H. The lower limit value of the dimension of the first line segment W with respect to the dimension of the second line segment H is preferably 1.5 times or more, and more preferably 3 times or more. In addition, the upper limit value of the dimension of the first line segment W with respect to the dimension of the second line segment H is preferably five times or less. In other words, the shape of the void 53 is substantially rectangular or substantially elliptical.

### (Method for Manufacturing Electronic Component)

Next, the method for manufacturing the electronic component 10 will be described.

As shown in FIG. 6, the method for manufacturing the electronic component 10 includes a base body preparation step S11, an R chamfering step S12, a solvent charging step S13, and a catalyst charging step S14. In addition, the method for manufacturing the electronic component 10 includes a base body charging step S15, a solution charging step S16, a medium charging step S17, a film forming step S18, and a drying step S19. The method for manufacturing the electronic component 10 further includes a first curing step S20, an internal electrode exposing step S21, a conductor applying step S22, a second curing step S23, and a plating step S24.

First, the base body preparation step S11 is performed. In the base body preparation step S11, a rectangular parallelepiped base body 20 having six planes is prepared. That is, the base body 20 at this stage is the base body 20 in a state before R-chamfering. For example, first, a plurality of ceramic sheets to be the base body 20 is prepared. The sheet has a thin plate shape. On the sheet, a conductive paste to serve as the first internal electrode 41 is laminated. A ceramic sheet to be the base body 20 is laminated on the conductive paste. On the sheet, a conductive paste to serve as the second internal electrode 42 is laminated. In this manner, the ceramic sheet and the conductive paste are laminated. Then, the base body 20 as an unfired laminate is formed by cutting into a predetermined size. Thereafter, the unfired base body 20 is fired at a high temperature to prepare the base body 20.

Next, as shown in FIG. 6, the R chamfering step S12 is performed. In the R chamfering step S12, a curved surface is formed at a boundary portion between two adjacent planes of the laminate prepared in the base body preparation step S11 and at a boundary portion between three adjacent planes. For example, the corner of the laminate is subjected to R chamfering by barrel polishing, whereby a curved surface is formed at the boundary portion.

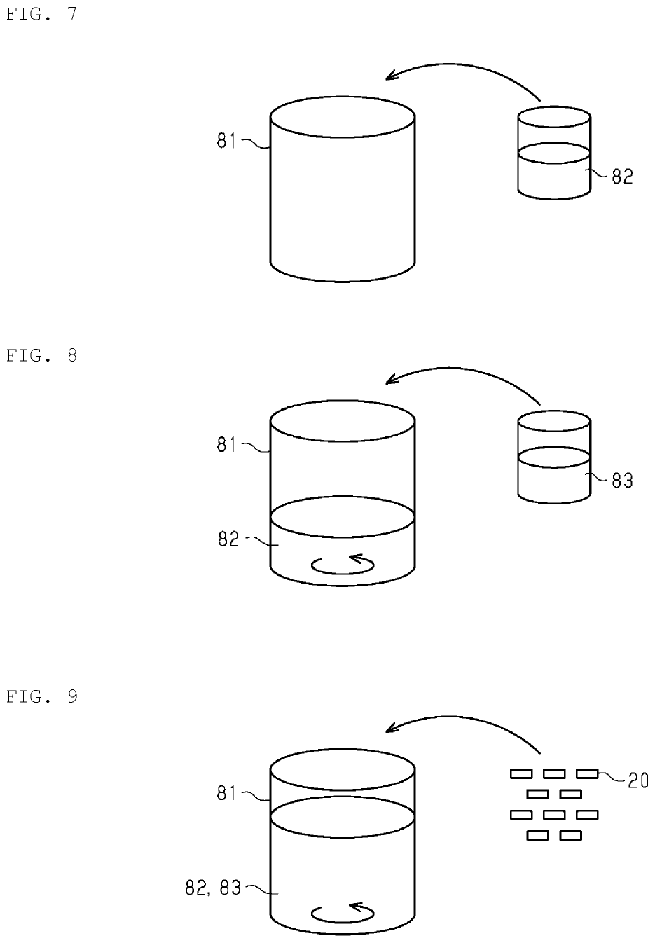

Next, as shown in FIG. 6, the solvent charging step S13 is performed. As shown in FIG. 7, in the solvent charging step S13, 2-propanol is charged as a solvent 82 into a reaction vessel 81.

Next, as shown in FIG. 6, the catalyst charging step S14 is performed. As shown in FIG. 8, in the catalyst charging step S14, first, stirring of the solvent 82 in the reaction vessel 81 is started. Then, as a solution 83 including a catalyst, ammonia water is put into the reaction vessel 81. The catalyst in this embodiment is a hydroxide ion, and functions as a catalyst that promotes hydrolysis of a metal alkoxide described later.

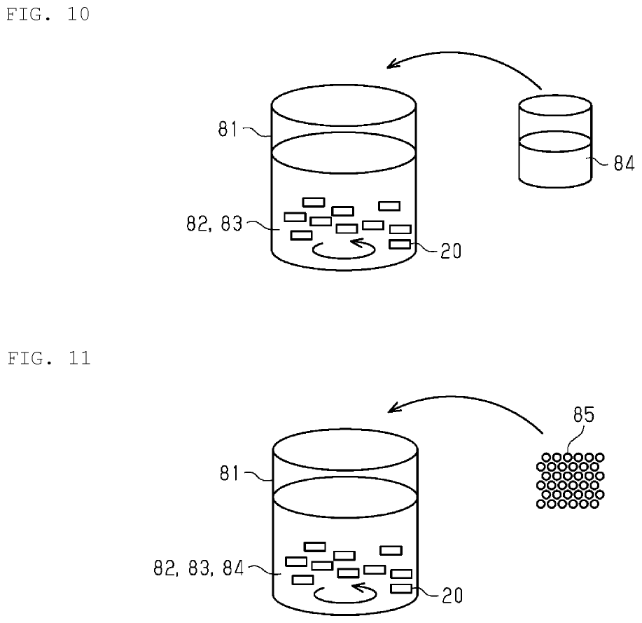

Next, as shown in FIG. 6, the base body charging step S15 is performed. As shown in FIG. 9, in the base body charging step S15, the plurality of base bodies 20 molded in the R chamfering step S12 are charged into the reaction vessel 81.

Next, as shown in FIG. 6, the solution charging step S16 is performed. As shown in FIG. 10, in the solution charging step S16, a mixed solution 84 which is a solution obtained by mixing a metal alkoxide and an organosilane compound is charged into the reaction vessel 81. The metal alkoxide is tetraethyl orthosilicate (hereinafter, referred to as “TEOS”) in a liquid state. It is noted that TEOS is also referred to as tetraethoxysilane. The organosilane compound is liquid GPTMS. GPTMS is charged at a weight ratio of 0.12 or more and less than 1 to TEOS. Specifically, GPTMS is charged at a weight ratio of about 0.43 to TEOS.

The amount of the mixed solution 84 to be charged in the solution charging step S16 is calculated based on the area of the outer surface 21 of the base body 20 charged in the base body charging step S15. Specifically, first, the amount of the mixed solution 84 necessary for forming the glass film 51 covering the outer surface 21 of the base body 20 is calculated for one base body 20. This amount is multiplied by the number of the base bodies 20 charged in the base body charging step S15 to calculate the required total amount of the mixed solution 84.

Next, as shown in FIG. 6, the medium charging step S17 is performed. As shown in FIG. 11, in the medium charging step S17, a medium 85 is charged into the reaction vessel 81. The medium 85 may also be referred to as spherical media. The medium 85 is in the form of powder having a higher hardness than the base body 20. Further, the medium 85 has a particle diameter greater than the maximum dimension L of a line segment connecting two points on the opening edge 25 of the recessed portion 24 of the outer surface 21 of the base body 20. Specifically, the particle diameter of the medium 85 is 0.05 mm or more and 5.0 mm or less. The hardness is a so-called indentation hardness, and is represented by, for example, Vickers hardness. The Vickers hardness is calculated by the area of the indentation applied to the sample when the diamond indenter is pushed into the sample.

In the present embodiment, the material of the medium 85 is zirconia. That is, the material of the medium 85 is zirconium oxide (ZrO₂) in the exemplary aspect. Zirconia as the medium 85 may be referred to as a zirconia ball. The particle diameter of the medium 85 to be charged into the reaction vessel 81 in the medium charging step S17 of the present embodiment is equal to or greater than the dimension of one specific side of the base body 20. Specifically, the dimension of one side of the first end surface 22A and the second end surface 22B of the base body 20 is about 0.3 mm, and the particle diameter of the medium 85 is about 0.3 mm or more.

In addition, the total amount of the medium 85 charged in the medium charging step S17 is 0.1 times or more the volume of the base body 20 charged in the base body charging step S15. The total amount of the medium 85 is determined so that the bath loading of the base body 20 and the medium 85 becomes a predetermined value. That is, first, the total value of the total area of the outer surface 21 of the base body 20 charged in the base body charging step S15 and the surface area of the entire medium 85 is calculated. The bath loading is a value obtained by dividing the total value by the total amount of the mixed solution 84 charged in the solution charging step S16. The unit of bath loading is, for example, “cm²/L”. The charged amount of the medium 85 is determined so that the value of the bath loading becomes a predetermined value.

Next, as shown in FIG. 6, the film forming step S18 is performed. In the film forming step S18, a sol-like glass film 51 is formed on the outer surface 21 of the base body 20 by using a liquid phase method. Specifically, first, the stirring of the solvent 82 started in the solvent charging step S13 is continued for a predetermined time. As a result, the metal alkoxide is hydrolyzed by a hydroxide ion as a catalyst and is subjected to condensation polymerization.

When the metal alkoxide is hydrolyzed and subjected to condensation polymerization, the metal alkoxide and the organosilane compound adhere to the outer surface 21 of the base body 20. By condensation polymerization of the metal alkoxides, the sol-like glass film 51 is formed on the outer surface 21 of the base body 20. In this case, each particle of the metal alkoxide condensation-polymerized on the outer surface 21 of the base body 20 grows into a particle having a relatively large volume. The grown particles of the metal alkoxide are bonded to each other with gaps of several nm or more. Therefore, the voids 53 caused by the gaps are generated inside the sol-like glass film 51 just formed on the outer surface 21 of the base body 20.

In the film forming step S18, stirring of the solvent 82 is continued as described above. Therefore, the medium 85 charged in the medium charging step S17 collides with the glass film 51 condensation-polymerized on the outer surface 21 of the base body 20. At the time of the film forming step S18, the glass film 51 is in a sol state. Therefore, when the medium 85 collides with the glass film 51, the glass film 51 is crushed and deformed. As a result, the void 53 generated inside the glass film 51 is crushed and filled. However, as described above, the particle diameter of the medium 85 is greater than the opening of the recessed portion 24. Therefore, the void 53 generated in the portion of the glass film 51 covering the flat portion 26 is crushed and filled over time, while the void 53 generated in the portion of the glass film 51 covering the recessed portion 24 remains without being crushed even after the film forming step S18 is performed. Therefore, as described above, the porosity at the portion of the glass film 51 covering the recessed portion 24 is greater than the porosity at the portion of the glass film 51 covering the flat portion 26.

In the film forming step S18, the sol-like glass film 51 is formed on the outer surface 21 of the base body 20 by a so-called barrel method. That is, since the reaction vessel 81 into which the plurality of base bodies 20 are charged is continuously stirred, the base bodies 20 also collide with each other. Therefore, the void 53 generated inside the sol-like glass film 51 covering the flat portion 26 is also crushed by the collision between the base bodies 20.

Next, the drying step S19 is performed. In the drying step S19, first, after the film forming step S18, the base body 20 is taken out from the reaction vessel 81. Next, the glass film 51 in the sol is dried. Thus, the gel-like glass film 51 is formed.

Next, a first curing step S20 is performed. In the first curing step S20, the base body 20 subjected to the drying step S19 is fired at a temperature of 140 °C or more and 160 °C or less. Specifically, firing is performed at a temperature of 150 °C. As a result, the gel-like glass film 51 is cured. That is, the entire glass film 51 is cured. At this stage, the glass film 51 covers the entire outer surface 21 of the base body 20.

Next, the internal electrode exposing step S21 is performed. In the internal electrode exposing step S21, the glass film 51 covering the first end surface 22A and the second end surface 22B of the base body 20 is removed to expose the first internal electrode 41 and the second internal electrode 42. In the present embodiment, the glass film 51 is removed by cutting the entire first end surface 22A and the entire second end surface 22B of the base body 20 with a laser.

Next, a conductor applying step S22 is performed. In the conductor applying step S22, a conductor paste is applied to a part of the outer surface 21 of the base body 20 and a part of the outer surface 52 of the glass film 51. Specifically, the conductor paste is applied to two places of the glass film 51 covering a part on a side of the first positive direction X1 of the four side surfaces 22C of the base body 20 and the first end surface 22A of the base body 20, and the glass film 51 covering a part on a side of the first negative direction X2 of the four side surfaces 22C of the base body 20 and the second end surface 22B of the base body 20.

Next, a second curing step S23 is performed. Specifically, in the second curing step S23, the base body 20 to which the conductor paste is applied is heated to cure the conductor paste. In the present embodiment, the base body 20 is heated at about 200 °C. Then, the conductor paste applied in the conductor applying step S22 is fired to form the first underlying electrode 61A and the second underlying electrode 62A.

Next, the plating step S24 is performed. In the plating step S24, electroplating is performed to form the first metal layer 61B on the surface of the first underlying electrode 61A. In addition, the second metal layer 62B is formed on the surface of the second underlying electrode 62A. Although not illustrated, the first metal layer 61B and the second metal layer 62B are electroplated with two kinds of nickel and tin to form a two-layer structure. In this way, the electronic component 10 is formed.

### (Technical Effects)

In the above embodiment, the glass film 51 has a plurality of voids 53. In a sectional view taken along a plane orthogonal to the outer surface 21 of the base body 20, a portion of the glass film 51 covering the recessed portion 24 has a porosity of 0.3% or more and 30% or less. As described above, since the glass film 51 has the plurality of voids 53, even if stress is generated at the above-described portion of the glass film 51, each void 53 buffers the stress. That is, the stress generated in the glass film 51 is dispersed in each void 53, and is less likely to concentrate on a specific portion. Therefore, cracks are less likely to occur at a portion of the glass film 51 that covers the recessed portion 24. When the porosity is 0.3% or more, an effect of making the glass film 51 less likely to be cracked is significantly obtained. On the other hand, since the porosity is 30% or less, the barrier property of the glass film 51 is not excessively impaired due to the void 53.

In the above embodiment, the average value of the thicknesses of the entire glass film 51 is 15 nm or more and 10 μm or less. In a case where the thickness of the glass film 51 is 15 nm or more, even if the glass film 51 has the void 53, it is possible to prevent moisture or the like from entering the void 53 and reaching the base body 20. That is, the barrier property and the like required for the glass film 51 is secured. In addition, in a case where the thickness of the glass film 51 is 10 μm or less, generation of cracks is significantly suppressed by the glass film 51 having the void 53. Therefore, the average value of the thicknesses of the entire glass film 51 is preferably within the above range.

In addition, in a case where the thickness of the glass film 51 is within the above range, the glass film 51 hardly interferes with other members than the glass film 51 of the electronic component 10. For example, when an external electrode is formed on the outer surface 21 of the base body 20, the presence of the glass film 51 is unlikely to interfere.

In the above embodiment, the thickness T1 of the portion of the glass film 51 covering the recessed portion 24 is greater than the thickness T2 of the portion covering the flat portion 26. Since the glass film 51 at the portion covering the recessed portion 24 is thick, it is easy to prevent ingress of moisture and the like. In addition, even if the glass film 51 is thick, since the glass film 51 has the void 53, stress is less likely to concentrate on a specific location. It is particularly preferable to adopt the configuration regarding the void 53 of the above embodiment for the glass film 51 in which the thickness T1 of the portion covering the recessed portion 24 is large as described above.

In the above embodiment, the porosity of the portion of the glass film 51 that covers the recessed portion 24 is greater than the porosity of the portion of the glass film 51 that covers the flat portion 26. The portion of the glass film 51 covering the recessed portion 24 is relatively more likely to be cracked than the portion covering the flat portion 26. Since the voids 53 are concentrated at the portion covering the recessed portion 24 of the glass film 51, it is possible to remarkably suppress the occurrence of cracks at the portion.

In the above embodiment, the shortest distance SD between the void 53 and the outer surface 21 of the base body 20 is 15 nm or more. In a case where the distance between the void 53 and the outer surface 21 of the base body 20 is short, there is a possibility that minute cracks starting from the void 53 or the void 53 reach the outer surface 21 of the base body 20. As described above, since the void 53 and the outer surface 21 of the base body 20 are separated from each other by 15 nm or more, it is possible to suppress the void 53 from reaching the base body 20 through the crack. Then, since the crack hardly reaches the base body 20, the adhesion of the glass film 51 to the base body 20 is hardly reduced.

In the above embodiment, in a sectional view taken along a plane orthogonal to the outer surface 21 of the base body 20, the area of the void 53 is 1 nm² or more and 10,000 nm² or less. In a case where the area of the void 53 is smaller than 1 nm², it is difficult to mitigate the stress generated in the glass film 51. On the other hand, in a case where the area of the void 53 is greater than 10,000 nm², the barrier property of the glass film 51 may be deteriorated. Therefore, the area of the void 53 is preferably within the above numerical range.

In the above embodiment, the dimension of the first line segment W is 1.01 times or more and 10 times or less the dimension of the second line segment H. In order to mitigate the stress generated in the glass film 51, the voids 53 are preferably uniformly distributed in the glass film 51. On the other hand, as the porosity increases, the barrier property of the glass film 51 may decrease. Therefore, since the voids 53 have the elongated shape as described above, the distribution of the voids 53 in the glass film 51 is close to uniform without significantly increasing the volume of the voids 53 in the glass film 51.

In the above embodiment, the maximum dimension L of the line segment LS connecting two points on the opening edge 25 of the recessed portion 24 is 0.5 μm or more and 20 μm or less. When the maximum dimension L of the line segment LS is 0.5 μm or more, the particles of the metal alkoxide easily adhere to the outer surface 21 of the base body 20, so that the glass film 51 is easily formed also in the recessed portion 24. In addition, in a case where the recessed portion 24 is large, when the surface of the glass film 51 is rubbed against an external object, the object is caught by the recessed portion 24, which may cause a scratch or the like in the base body 20. Therefore, when the maximum dimension L of the line segment LS is 20 μm or less, the strength of the glass film 51 as a whole is less likely to decrease.

In the above embodiment, the maximum depth HD of the recessed portion 24 is 0.3 μm or more and 10 μm or less. If the maximum depth HD of the recessed portion 24 is less than 0.3 μm, there is a possibility that an external object and a portion of the glass film 51 covering the recessed portion 24 are likely to come into contact with each other. As described above, since the recessed portion 24 is caused by cracking and chipping of the base body 20, the arithmetic average roughness of the recessed portion 24 tends to be greater than that of the flat portion 26. When the arithmetic average roughness is large, the frictional force applied to the outer surface 52 of the glass film 51 tends to be large, so that a crack or the like may occur at a portion covering the recessed portion 24 of the glass film 51. Therefore, the maximum depth HD of the recessed portion 24 is preferably 0.3 μm or more. In addition, in a case where the maximum depth HD of the recessed portion 24 is greater than 10 μm, there is a possibility that the thickness T2 of the glass film 51 in the vicinity of the opening edge 25 of the recessed portion 24 becomes excessively small. In this case, cracks are likely to occur in the glass film 51 in the vicinity of the opening edge 25 of the recessed portion 24. Therefore, the maximum depth HD of the recessed portion 24 is preferably 10 μm or less.

In the above embodiment, the arithmetic average roughness of the recessed portion 24 is 6 nm or more and 500 nm or less. Since the shape of the outer surface 52 of the glass film 51 follows the shape of the outer surface 21 of the base body 20 to some extent, the arithmetic average roughness of the outer surface 52 of the glass film 51 is also 500 nm or less. In a case where the arithmetic average roughness of the recessed portion 24 is within the above numerical range, even if stress is generated in the glass film 51 due to rubbing between an external object and the recessed portion 24, the glass film 51 has the void 53, so that generation of cracks is significantly suppressed.

In the above embodiment, the method for manufacturing the electronic component 10 includes the medium charging step S17. The particle diameter of the medium 85 is greater than the maximum dimension L of the line segment LS connecting two points on the opening edge 25 of the recessed portion 24. Thus, the medium 85 is less likely to come into contact with the portion covering the recessed portion 24 of the glass film 51. Therefore, in the film forming step S18, the glass film 51 in which the porosity of the recessed portion 24 is greater than that of the flat portion 26 is formed.

In the above embodiment, in the medium charging step S17, a zirconia ball as the medium 85 is charged into the reaction vessel 81. Since zirconia has higher hardness and durability than other ceramics, it is suitable as the medium 85.

In the recessed portion 24 of the base body 20, for example, particles and the like falling off from the base body 20 tend to remain as foreign matters. In a case where foreign matter remains in the recessed portion 24, foreign matter remains in the glass film 51. In a case where the thermal expansion coefficient of the glass film 51 is different from the thermal expansion coefficient of the foreign matter, stress is likely to occur in the vicinity of the interface with the foreign substance in the glass film 51 due to a change in temperature. According to the above embodiment, even if foreign matter remains in the glass film 51 covering the recessed portion 24, the glass film 51 has the void 53, so that the stress is mitigated.

### Modification Examples

It is noted in general that the above-mentioned embodiments and the following modifications can be implemented in combination within a range that is not technically contradictory.

In particular, the electronic component 10 is not limited to a negative-characteristic thermistor component. For example, the electronic component 10 may be a thermistor component other than those that have negative characteristics or may be a multilayer capacitor component or an inductor component, as long as the electronic component 10 includes some wiring inside the base body 20.

Moreover, the material of the base body 20 is not limited to the example of the exemplary embodiment. For example, the material of the base body 20 may be a composite body of a resin and a metal powder, a fiber, a thermosetting resin, or the like.

It is also noted that the shape of the base body 20 is not limited to the example of the exemplary embodiment. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.

Of the outer surface 21 of the base body 20, a boundary portion between the adjacent planes may not have a chamfered shape. In this case, there is no curved surface at the boundary portion.

The shapes of the first internal electrodes 41 and second internal electrodes 42 are not limited as long as the shapes can ensure electrical conduction with the corresponding first external electrode 61 and second external electrode 62. In addition, the number of the first internal electrode 41 and the number of the second internal electrode 42 are not limited, and the number of the internal electrode may be one or may be three or more.

The configuration of the first external electrode 61 is not limited to the example of the embodiment mentioned above. For example, the first external electrode 61 may include only the first underlying electrode 61A, or the first metal layer 61B may have no two-layer structure. Further, the electronic component 10 may not have the first external electrode 61, and the first internal electrode 41 may be exposed at the first end surface 22A. That is, the end surface of the first internal electrode 41 may function as an external electrode. In this respect, the same applies to the second external electrode 62.

It is also noted that the materials of the first internal electrode 41, the second internal electrode 42, the first external electrode 61, and the second external electrode 62 are not limited to the examples of the above embodiment. It is only necessary to ensure electrical conduction between the first internal electrode 41 and the second internal electrode 42, and the corresponding first external electrode 61 and second external electrode 62, respectively, according to the exemplary aspects.

Yet further, the configuration of the glass film 51 is not limited to the example of the above embodiment. For example, the range covered by the glass film 51 may be appropriately changed in accordance with the shape of the base body 20, the positions of the first external electrode 61 and the second external electrode 62, and the like. The glass film 51 may cover at least the outer surface 21 including the recessed portion 24 of the base body 20, and the porosity at the portion covering the recessed portion 24 of the glass film 51 may be within the above-described range.

According to an exemplary aspect, the maximum depth HD of the recessed portion 24 may be less than 0.3 μm or greater than 10 μm. The maximum dimension L of the line segment LS connecting two points on the opening edge 25 of the recessed portion 24 may be less than 0.5 μm or greater than 20 μm. Irrespective of the size of the recessed portion 24, the presence of the void 53 in a portion covering the recessed portion 24 of the glass film 51 can suppress generation of a crack in the portion.

According to an exemplary aspect, the arithmetic average roughness of the recessed portion 24 of the outer surface 21 of the base body 20 may be less than 6 nm or greater than 500 nm. Regardless of the arithmetic average roughness of the recessed portion 24, the stress generated in the glass film 51 by the void 53 is mitigated.

According to an exemplary aspect, the average value of the thickness T2 of the glass film 51 covering the recessed portion 24 may be equal to or less than the average value of the thickness T1 of the glass film 51 covering the flat portion 26. Regardless of the relationship of the thickness of the glass film 51, at least the effect described above is obtained.

According to an exemplary aspect, in a sectional view taken along a plane orthogonal to the outer surface 21 of the base body 20, the area of the void 53 may be less than 1 nm² or greater than 10,000 nm². The suitable area of the void 53 can vary depending on, for example, the dimension of the base body 20, the average value of the thickness of the glass film 51, and the like. Even if the area of the void 53 is small, the stress generated in the glass film 51 is mitigated if the porosity at the portion covering the recessed portion 24 of the glass film 51 is high in the range of 30% or less. In addition, even if the area of the void 53 is large, the barrier property of the glass film 51 is not excessively lowered as long as the porosity is small in the range of 0.3% or more.

According to an exemplary aspect, the porosity at the portion of the glass film 51 covering the recessed portion 24 may be equal to or less than the porosity at the portion covering the flat portion 26. In addition, the porosity at the portion covering the flat portion 26 of the glass film 51 may be 0.3% or more. For example, when the medium charging step S17 is omitted in the method for manufacturing the electronic component 10, the porosity at the portion covering the flat portion 26 of the glass film 51 is increased. Even in this case, at least the technical effect described above is obtained as the porosity at the portion of the glass film 51 covering the recessed portion 24 is within the predetermined range.

According to an exemplary aspect, the dimension of the first line segment W may be 1 time or more, or 10 times or more than the dimension of the second line segment H. Regardless of the shape of the void 53, at least the technical effect described above is obtained.

It is also noted that the solvent 82 charged in the solvent charging step S13 is not limited to the example of the embodiment mentioned above and may be any liquid that can disperse the metal alkoxide appropriately.

The solvent charging step S13 may be performed after the catalyst charging step S14 and the base body charging step S15. The solvent charging step S13 may be performed before at least one of the solution charging step S16 and the catalyst charging step S14. In addition, the solvent charging step S13 may be omitted. In this case, for example, in a case where the amount of water included in the solution 83 including the catalyst is appropriately large, the metal alkoxide reacts in the liquid phase. In addition, the solution 83 including the catalyst may be charged in a state of being mixed with an organic solvent as the solvent 82.

In the above embodiment, the solution 83 including the catalyst is ammonia water, and the catalyst is hydroxide ions, but the catalyst is not limited thereto. In a case where the solution is a basic solution, the hydrolysis of the metal alkoxide as a catalyst can be promoted similarly to the ammonia water of the above embodiment. In addition, an acidic solution can promote the hydrolysis of the metal alkoxide as a catalyst. Furthermore, a neutral solution may include a substance functioning as a catalyst, such as an ion capable of promoting hydrolysis.

It is also noted that although it has been described that the catalyst is charged as the solution 83 including the catalyst, a solid compound including the catalyst and water may be separately charged into the reaction vessel 81. In this case, it can be considered that the catalyst is charged into the reaction vessel 81 because the catalyst is generated in the reaction vessel 81. In addition, for example, a solid compound including a catalyst may be charged into the reaction vessel 81, or water required for hydrolysis may be moisture in the air.

According to an exemplary aspect, the base body charging step S15 may be performed before the catalyst charging step S14. When the base body charging step S15 is performed before the catalyst charging step S14, the solution charging step S16 may be performed before the catalyst charging step S14 or the base body charging step S15. At least the base body charging step S15 may be performed before any one of the solution charging step S16 and the catalyst charging step S14.

In the solution charging step S16, it is not necessary to produce the metal alkoxide outside the reaction vessel 81 in advance, and the metal alkoxide may be produced in the reaction vessel 81. For example, metal alkoxides are also produced by chemical reactions between metal salts and alcohols. Therefore, in the solution charging step S16, a metal salt and an alcohol which are metal alkoxide precursors may be charged in the reaction vessel 81. That is, even in a case where the metal alkoxide is produced in the reaction vessel 81, the metal alkoxide is charged into the reaction vessel 81.

It is noted that the metal alkoxide is not limited to TEOS. For example, titanium, aluminum, or the like may be used as the metal contained in the metal alkoxide. When the metal contained in the metal alkoxide is silicon, the reaction rate is slower than that of other metals, so that the reaction rate of the metal alkoxide is easily controlled to be constant. The alkoxy group of the metal alkoxide may be a methoxy group, a propoxy group, or the like. Furthermore, the coordination number with respect to the metal contained in the metal alkoxide is not limited to being four-coordination and may be three-coordination or two-coordination.

In the above embodiment, the organosilane compound is not limited to GPTMS. The organosilane compound may have none of an epoxy group, a mercapto group, an amino group, a vinyl group, and a methacryl group. For example, the organosilane compound may be an organosilane compound such as 3-aminopropyltrimethoxysilane, 3-aminopropyltriethoxysilane, 3-(2-aminoethyl)aminopropyltrimethoxysilane, 3-phenylaminopropyltrimethoxysilane, (3-glycidoxypropyl)methyldimethoxysilane, 3-methacryloxypropyltrimethoxysilane, 3-methacryloxypropylmethyldimethoxysilane, 3-mercaptopropyltrimethoxysilane, n-propyltrimethoxysilane, isobutyltrimethoxysilane, n-hexyltrimethoxysilane, or n-decyltrimethoxysilane. The inclusion of the organosilane compound in the glass film 51 can be specified by using a method such as X-ray photoelectron spectroscopy, Fourier transform infrared spectrophotometer, Raman spectroscopy, or energy dispersive X-ray analysis.

According to an exemplary aspect, the glass film 50 may include one or more compounds selected from an organic titanium compound, an organic aluminum compound, and an organic zirconium compound in place of or in addition to the organosilane compound. These compounds also have a function as a coupling agent similarly to the organosilane compound and thus can function similarly to the example of the above embodiment.

In the solution charging step S16, the mixed solution 84 of the metal alkoxide and the organosilane compound does not need to be mixed in advance. The metal alkoxide and the organosilane compound may be individually charged into the reaction vessel 81 at a predetermined ratio. Even in this case, the mixed solution 84 is charged into the reaction vessel 81.

In the solution charging step S16, the weight ratio of the organosilane compound to the metal alkoxide to be charged into the reaction vessel 81 is not limited to the example of the above embodiment.

As long as the glass film 51 can be formed, the order of performing the first curing step S20 may not be after the drying step S19. For example, in the second curing step S23, the glass film 51 may be cured together with the firing of the conductor paste.

According to an exemplary aspect, the medium charging step S17 may be performed before the film forming step S18 is performed or during the film forming step S18. For example, in the base body charging step S15, the base body 20 and the medium 85 may be charged into the reaction vessel 81 at the same time. However, when the medium 85 is charged during the film forming step S18, it is necessary to stir the liquid in the reaction vessel 81 after at least the medium 85 is charged into the reaction vessel 81.

According to an exemplary aspect, the material of the medium 85 to be charged in the medium charging step S17 may not be zirconia. For example, the material of the medium 85 may be alumina spherical stone or other ceramics in various exemplary aspects. At least the medium 85 may be in the form of powder having a higher hardness than the base body 20, and may have a particle diameter greater than the maximum dimension L of a line segment connecting two points on the opening edge 25 of the recessed portion 24 of the outer surface 21 of the base body 20.

The particle diameter of the medium 85 to be charged in the medium charging step S17 may be less than 0.05 mm or greater than 5.0 mm. The particle diameter of the medium 85 may be appropriately changed according to the size of the electronic component 10 to be manufactured and the size of the recessed portion 24.

According to an exemplary aspect, the total amount of the medium 85 to be charged into the reaction vessel 81 in the medium charging step S17 may be less than 0.1 times the volume of the base body 20. The total amount of the medium 85 to be charged may be appropriately changed depending on the design value of the bath loading.

In the internal electrode exposing step S21, the method of removing the glass film 51 is not limited to laser cutting. For example, the first internal electrode 41 and the second internal electrode 42 may be exposed using a method such as ion milling or polishing.

In the internal electrode exposing step S21, the range in which the glass film 51 is removed is not limited to the example of the above embodiment. It is noted that it is sufficient that at least the first internal electrode 41 and the second internal electrode 42 be electrically connected to the corresponding first underlying electrode 61A and second underlying electrode 62A, respectively.

It is also noted that the second curing step S23 is not limited to heating of the conductor paste. For example, in a case where a material that is cured by ultraviolet irradiation is used as the conductor paste, the material may be cured by ultraviolet irradiation.

### DESCRIPTION OF REFERENCE SYMBOLS

10: Electronic component
20: Base body
21: Outer surface
51: Glass film
52: Outer surface
53: Void
T1: Thickness
T2: Thickness
W: First line segment
H: Second line segment
85: Medium

What is claimed:

1. An electronic component comprising:
a base body; and
a glass film covering an outer surface of the base body,
wherein:
the outer surface of the base body includes a recessed portion that is recessed relative to surrounding surfaces,
the glass film has a plurality of voids therein,
a portion of the outer surface of the base body that excludes the recessed portion is a flat portion, and
in a sectional view taken along a plane orthogonal to the outer surface of the base body, a ratio of a total area of the plurality of voids to a sectional area of the glass film at a portion covering the recessed portion in the glass film is greater than a ratio of a total area of the plurality of voids to a sectional area of the glass film at a portion covering the flat portion in the glass film.

2. The electronic component according to claim 1, wherein a material of the glass film includes one or more compounds selected from an organosilane compound, an organic titanium compound, an organic aluminum compound, and an organic zirconium compound.

3. The electronic component according to claim 1, wherein, in the sectional view taken along the plane orthogonal to the outer surface of the base body, the ratio of a total area of the plurality of voids to the sectional area of the glass film is 0.3% or more at a portion covering the recessed portion in the glass film.

4. The electronic component according to claim 3, wherein, in the sectional view taken along the plane orthogonal to the outer surface of the base body, the ratio of the total area of the plurality of voids to the sectional area of the glass film is 30% or less at the portion covering the recessed portion in the glass film.

5. The electronic component according to claim 1, wherein the ratio of the total area of the plurality of voids to the sectional area of the glass film is 30% or less at a portion covering the recessed portion in the glass film.

6. The electronic component according to claim 1, wherein an average value of a thickness of the glass film is 15 nm or more and 10 μm or less.

7. The electronic component according to claim 1, wherein an average value of a thickness of the glass film covering the recessed portion is greater than an average value of a thickness of the glass film covering the flat portion.

8. The electronic component according to claim 1, wherein a shortest distance between each of the plurality of voids and the outer surface of the base body is at least 15 nm.

9. The electronic component according to claim 1, wherein, in the sectional view taken along the plane orthogonal to the outer surface of the base body, an area per void is 1 nm² or more and 10,000 nm² or less.

10. The electronic component according to claim 1, wherein, in the sectional view taken along the plane orthogonal to the outer surface of the base body, a plurality of line segments connect two points on an outer edge of a void of the plurality of voids, a line segment of the plurality of line segments that has a maximum distance between the two points is defined as a first line segment, a line segment of the plurality of line segments that passes through a midpoint of the first line segment and is orthogonal to the first line segment is defined as a second line segment, and a dimension of the first line segment is 1.01 times or more and 10 times or less than a dimension of the second line segment.

11. The electronic component according to claim 1, wherein a maximum dimension of a line segment connecting two points on an opening edge of the recessed portion is 0.5 μm or more and 20 μm or less.

12. The electronic component according to claim 1, wherein a maximum depth of the recessed portion is 0.3 μm or more and 10 μm or less.

13. The electronic component according to claim 1, wherein the recessed portion of the outer surface of the base body has an arithmetic average roughness of 6 nm or more and 500 nm or less.

14. The electronic component according to claim 1, wherein a material of the glass film comprises an organosilane compound having one or more functional groups selected from an epoxy group, a mercapto group, an amino group, a vinyl group, and a methacryl group.

15. The electronic component according to claim 1, wherein the recessed portion has a maximum depth that is 10 times or greater than an arithmetic average roughness of the outer surface of the base body.

16. The electronic component according to claim 1, wherein a porosity at a portion of the glass film that covers the recessed portion of the outer surface of the base body is greater than a porosity at a portion of the glass film that covers the flat portion of the outer surface of the base body.

17. An electronic component comprising:
a base body; and
a glass film covering an outer surface of the base body,
wherein the outer surface of the base body includes a recessed portion that is recessed relative to surrounding surfaces,
wherein the glass film has a plurality of voids therein, and
wherein, in a sectional view taken along a plane orthogonal to the outer surface of the base body, a ratio of a total area of the plurality of voids to a sectional area of the glass film is 0.3% or more and 30% or less at a portion covering the recessed portion in the glass film.

18. The electronic component according to claim 17, wherein:
a portion of the outer surface of the base body that excludes the recessed portion is a flat portion, and
in the sectional view taken along the plane orthogonal to the outer surface of the base body, a ratio of a total area of the plurality of voids to a sectional area of the glass film at a portion covering the recessed portion in the glass film is greater than a ratio of a total area of the plurality of voids to a sectional area of the glass film at a portion covering the flat portion in the glass film.

19. The electronic component according to claim 17, wherein a material of the glass film includes one or more compounds selected from an organosilane compound, an organic titanium compound, an organic aluminum compound, and an organic zirconium compound.

20. A method for manufacturing an electronic component, the method comprising:
preparing a base body;
charging the base body into a reaction vessel;
charging one or more elements selected from a metal alkoxide and a metal alkoxide precursor, together with an organosilane compound into the reaction vessel;
forming a glass film on an outer surface of the base body by stirring within the reaction vessel and hydrolyzing and condensation-polymerizing the metal alkoxide; and
charging a medium which is in a powder form having a higher hardness than the base body and has a particle diameter greater than a maximum dimension of a line segment connecting two points on an opening edge of a recessed portion included in an outer surface of the base body into the reaction vessel,
wherein the charging of the medium is performed before or during the forming of the glass film.
